(19) United States
(12) Patent Application Publication
(10) Pub. No.: US 2012/0092489 A1
(43) Pub. Date: Apr. 19, 2012

(54) IMAGE RECOGNIZING METHOD AND IMAGE RECOGNIZING DEVICE

(75) Inventors: Chun-Gi LYUH, Daejeon (KR); Ik Jae Chun, Daejeon (KR); Jung Hee Suk, Daejeon (KR); Sanghun Yoon, Daejeon (KR); Tae Moon Roh, Daejeon (KR)

(73) Assignee: Electronics and Telecommunications Research Institute, Daejeon (KR)

(21) Appl. No.: 13/012,246

(22) Filed: Jan. 24, 2011

(30) Foreign Application Priority Data
Oct. 14, 2010 (KR) 10-2010-0100399

(51) Int. Cl. H04N 7/18; G06K 9/46

(52) U.S. Cl. 348/135; 382/190

(57) ABSTRACT

Provided is an image recognizing method. The image recognizing method includes selecting a partial data from a standard image data, recognizing image based on the selected data, reduction-converting the selected data, and recognizing image based on the reduction-converted data.

### CROSS-REFERENCE TO RELATED APPLICATIONS

This U.S. non-provisional patent application claims priority under 35 U.S.C. §119 of Korean Patent Application No. 10-2010-0100399, filed on Oct. 14, 2010, in the Korean Intellectual Property Office (KIPO), the entire contents of which are hereby incorporated by reference.

### BACKGROUND OF THE INVENTION

The present invention disclosed herein relates to a method for recognizing an image and an image recognizing device.

Image recognition is to determine whether there exists an object such as a human being and a car on an image acquired through an image acquisition device such as a camera or a camcorder. A research on the image recognition is widely conducted in various fields, e.g., an alerting system and a driving system of a car and a control system of a robot.

There are various objects on an image acquired in a life environment. An early image recognition technology has been developed for improving accuracy of detecting a target object from various objects on the acquired image. The accuracy of image recognition has been improved and equalized with development of the image recognition technology. However a research is still needed for reducing unit cost and size of the image recognizing device.

### SUMMARY OF THE INVENTION

The present invention provides an image recognizing device and a method of the same for reducing required storage amount.

Embodiments of the present invention provide methods for recognizing an image including selecting a partial data from a standard image data; recognizing image based on the selected data; reduction-converting the selected data; and recognizing image based on the reduction-converted data.

In some embodiments, the method may further include reselecting a partial data from the selected data and unselected data from the standard image data; recognizing image based on the reselected data; reduction-converting the reselected data; and recognizing image based on the reduction-converted data of the reselected data.

In other embodiments of the present invention, image recognizing devices include an image acquirer; a standard image memory configured to store a partial data of a standard image data acquired by the image acquirer; a first reducer configured to reduction-convert the data stored in the standard image memory; a reduced image memory configured to store an output data of the first reducer; a search window setter configured to set a search window based on the data stored in the standard image memory and the data stored in the reduced image memory; and an image recognition processor configured to recognize image based on the search window set by the search window setter.

In some embodiments, the search window setter may be configured to set the search window based on the data stored in the reduced image memory after the recognizing image based on the data stored in the standard image memory is finished.

In other embodiments, the standard image memory may include a storage capacity corresponding to a horizontal resolution of the search window and a vertical resolution of the image acquirer.

In still other embodiments, the reduced image memory may include a storage capacity corresponding to a horizontal resolution of the search window and a vertical resolution to which a vertical resolution of the image acquirer are reduction-converted by the first reducer.

In even other embodiments, the search window setter may be configured to set the search window based on the data stored in the reduced image memory after data corresponding to a horizontal resolution of the search window and a vertical resolution to which a vertical resolution of the image acquirer are reduction-converted by the first reducer is stored in the reduced image memory.

In yet other embodiments, partial data may be deleted from the data stored in the standard image memory and data with a capacity corresponding to the deleted data is additionally stored in the standard image memory after the recognizing image based on the data stored in the standard image memory is finished.

In further embodiments, the search window setter may be configured to reset the search window based on the data stored in the standard image memory after the standard image memory is updated.

In still further embodiments, the standard image memory may be updated based on a First-In First-Out (FIFO) method.

In even further embodiments, the first reducer may be configured to reduction-convert the data additionally stored in the standard image memory.

In yet further embodiments, data to which the additionally stored data in the standard image memory is reduction-converted may be stored in a free space of the reduced image memory when the free space exists in the reduced image memory.

In much further embodiments, data with a capacity corresponding to data to which the additionally stored data in the standard image memory is reduction-converted may be deleted from the data stored in the reduced image memory and the data to which the additionally stored data in the standard image memory is reduction-converted may be stored into the reduced image memory when a free space does not exist in the reduced image memory.

In still much further embodiments, the reduced image memory may be updated in a FIFO method.

In even much further embodiments, the standard image memory may be updated when there are data still not stored in the standard image memory among the standard image data after the recognizing image based on the data stored in the reduced image memory is finished.

In yet much further embodiments, the image recognizing device may further include a second reducer having a different reduction ratio from that of the first reducer; a second reduced image memory configured to store an output data of the second reducer, wherein the second reducer is configured to reduction-convert the data stored in the standard image memory and store the converted data into the second reduced image memory.

In still yet much further embodiments, the search window setter may be configured to set the search window based on the data stored in the second reduced image memory after the recognizing image based on the data stored in the reduced image memory is finished.

In still yet much further embodiments, the image recognizing device may further include a third reducer configured to reduction-covert the data stored in the reduced image memory; a third reduced image memory configured to store an output data of the third reducer; a fourth reducer configured to reduction-convert the data stored in the reduced image memory having a different reduction ratio from that of the third reducer; and a fourth reduced image memory configured to store an output data of the fourth reducer.

In still yet much further embodiments, the image recognizing device may further include second to nth reduced image memories; a multiplexer configured to transfer data stored in one of the standard image memory, the reduced image memory, and the second to nth reduced image memories to the first reducer; and a demultiplexer configured to transfer an output of the first reducer to one of the reduced image memory and the second to nth reduced image memories.

In still yet much further embodiments, the data stored in the standard image memory may be transferred to the reduced image memory through the multiplexer, the first reducer, and the demultiplexer, the data stored in the reduced image memory may be transferred to the second reduced image memory through the multiplexer, the reducer, and the demultiplexer, the data stored in the kth reduced image memory among the second to nth reduced image memories may be transferred to (k+1)th reduced image memory through the multiplexer, the first reducer, and the demultiplexer, wherein k is an integer equal to or larger than 2.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating an image recognizing device according to an embodiment of the present invention;

FIG. 2 is a diagram illustrating an image acquired by an image acquirer and a search window set by a search window setter;

FIG. 3 is a diagram illustrating an image which is acquired by an image acquirer and reduced by 1/N and a search window set by a search window setter;

FIG. 4 is a block diagram illustrating an image controller according to a first embodiment of the present invention;

FIG. 5 is a block diagram illustrating an image controller according to a second embodiment of the present invention;

FIGS. 6 to 10 are diagrams for describing an operation method of the image recognizing device including an image controller of FIG. 5;

FIG. 11 is a block diagram illustrating an image controller according to a third embodiment of the present invention;

FIG. 12 is a block diagram illustrating an image controller according to a fourth embodiment of the present invention; and

FIG. 13 is a flowchart illustrating an operation method of the image recognizing device according to the embodiment of the present invention.

FIG. 14 is a diagram illustrating an image recognition system according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. The same or like reference numerals refer to the same or like elements throughout.

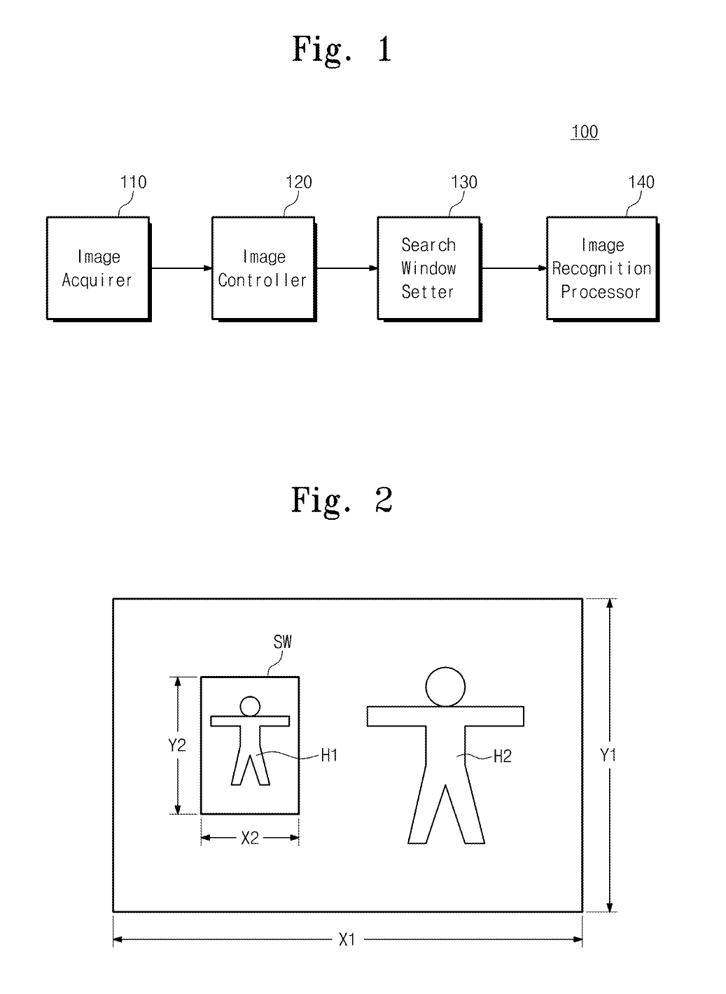

FIG. 1 is a block diagram illustrating an image recognizing device 100 according to an embodiment of the present invention. Referring to FIG. 1, the image recognizing device 100 includes an image acquirer 110, an image controller 120, a search window setter 130, and an image recognition processor 140.

The image acquirer 110 is configured to acquire an image. For instance, the image acquirer 110 may include a camera and a camcorder.

The image controller 120 is configured to receive the acquired image data from the image acquirer 110. The image controller 120 is configured to process the received image data and provide the processed data to the search window setter 130.

The search window setter 130 is configured to set a search window based on the data provided by the image controller 120.

The image recognition processor 140 is configured to detect a target object within the search window set by the search window setter 130.

For instance, the image controller 120 may provide a processed image data having a resolution which is equal to or larger than that of the search window to the search windows setter 130. Herein, the search window setter 130 may set the search window based on the data provided by the image controller 120. After image recognition within the set search window is finished, the search window setter 130 may reset the search window based on the data provided by the image controller 120. The firstly set search window and the reset search window may include an overlapping section. The number of times setting the search window based on the data provided by the image controller 120 may be variously changed according to an algorithm.

FIG. 2 is a diagram illustrating an image acquired by the image acquirer 110 and a search window SW set by the search window setter 130. Referring to FIGS. 1 and 2, the image acquired by the image acquirer 110 has a horizontal resolution X1 and a vertical resolution Y1. The search window set by the search window setter 130 has a horizontal resolution X2 and a vertical resolution Y2.

For instance, it is assumed that the target object recognized by the image recognizing device is a human. The image acquired by the image acquirer 110 includes a first human H1 and a second human H2. On the acquired image, the first human H1 has a smaller size than that of the search window SW. In detail, the first human H1 has a size recognizable to the image recognition processor 140 within the search window SW.

On the acquired image, a size of the second human H2 is larger than that of the search window SW. That is, just a part of the second human H2 is included within the search window SW. Accordingly, the second human H2 cannot be recognized by the image recognition processor 140.

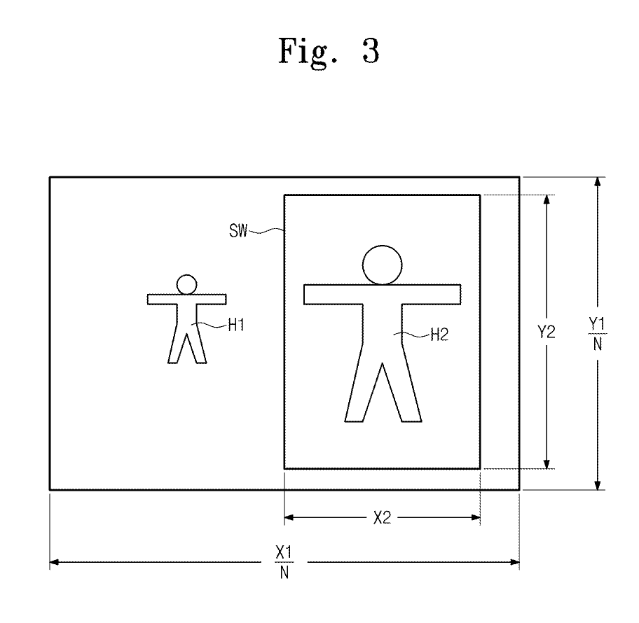

FIG. 3 is a diagram illustrating an image which is acquired by the image acquirer 110 and reduced by 1/N and the search window SW set by the search window setter 130. Referring to FIGS. 1 and 3, the reduced image has a horizontal resolution X1/N and a vertical resolution Y1/N. The search window SW has a horizontal resolution X2 and a vertical resolution Y2.

The image acquired by the image acquirer 110 is reduced and the size of the search window SW is maintained. Herein, in comparison with the size of the search window SW, the sizes of the first and second humans H1 and H2 on the acquired image are reduced. That is, the second human H2 having the larger size than that of the search window SW on the acquired image of FIG. 2 may has a smaller size than that of the search window SW on the reduced image as illustrated in FIG. 3. That is, the second human H2 may also be recognized by the image recognition processor 140.

In this way, if the search window setting and the image recognition are performed to the acquired image and if the acquired image is reduced and the search window setting and the image recognition are performed to the reduced image, all the target objects smaller than or larger than the search window SW on the acquired image may be recognized.

On the acquired image, the size of the first human H1 is smaller than that of the second human H2. That is, a distance between the first human H1 and the image acquirer 110 is larger than that between the second human H2 and the image acquirer 110. If the image recognition is performed to the acquired image and the reduced image, regardless of the distance between the image acquirer 110 and the target object, the target object may be recognized.

The image controller 120 is configured to acquire an image through the image acquirer 110 and provide the acquired image to the search window setter 130. Also, the image controller 120 is configured to reduce the image acquired through the image acquirer 110 and provide the reduced image to the search window setter 130. Herein, the image acquired by the image acquirer 110 is defined as a standard image, and the image reduced by the image controller 120 is defined as a reduced image.

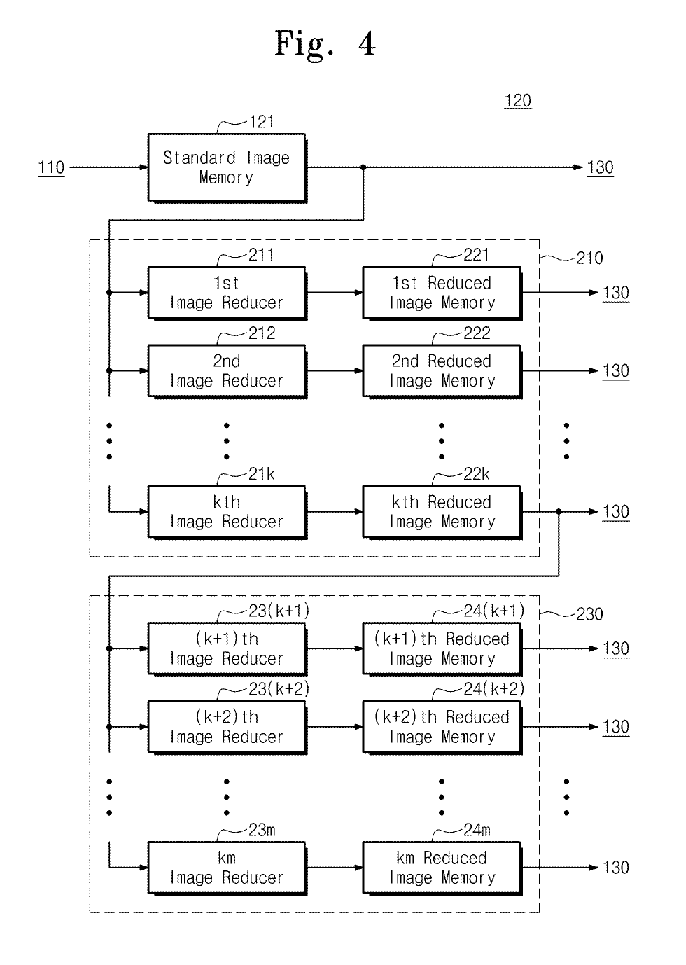

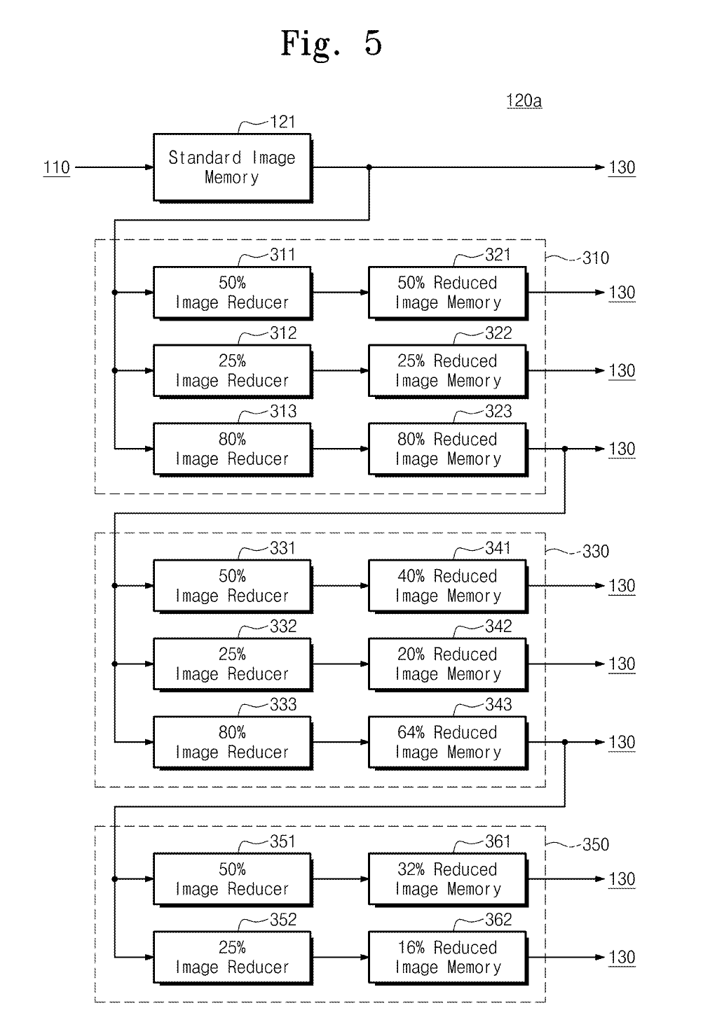

FIG. 4 is a block diagram illustrating the image controller 120 according to a first embodiment of the present invention. Referring to FIG. 4, the image controller 120 includes a standard image memory 121, a first image reduction unit 210, and a second image reduction unit 230.

The standard image memory 121 is configured to store data received from the image acquirer 110. For instance, a storage capacity of the standard image memory 121 may be smaller than a capacity of the standard image acquired through the image acquirer 110. The storage capacity of the standard image memory 121 may correspond to the horizontal resolution of the search window SW and the vertical resolution of the standard image. The data stored in the standard image memory 121 is provided to the search window setter 130 and the first image reduction unit 210.

The first image reduction unit 210 is configured to reduction-convert the data stored in the standard image memory 121. The second image reduction unit 230 is configured to reduction-convert the reduction-converted data additionally.

The first image reduction unit 210 is configured to receive the data stored in the standard image memory 121. The first image reduction unit 210 includes a first image reducer 211 to a kth image reducer 21k and a first reduced image memory 221 to a kth reduced image memory 22k.

The first to kth image reducers 211 to 21k are configured to receive the data stored in the standard image memory 121. The first to kth image reducers 211 to 21k are respectively configured to reduction-convert the data received from the standard image memory 121. The first to kth image reducers 211 to 21k are configured to have different reduction ratios. The image data reduced with different ratios by the first to kth image reducers 211 to 21k are respectively stored into the first to kth reduced image memories 221 to 22k.

The data stored in the first to kth reduced image memories 221 to 22k are provided to the search window setter 130. That is, reduced images of the standard image with different reduction ratios are provided to the search window setter 130.

The data stored in the kth reduced image memory 22k is additionally provided to the second image reduction unit 230.

The second image reduction unit 230 receives the data stored in the kth reduced image memory 22k of the first image reduction unit 210. The second image reduction unit 230 includes a (k+1)th image reducer 23(k+1) to an mth image reducer 23m and a (k+1)th reduced image memory 24(k+1) to an mth reduced image memory 24m.

The (k+1)th to mth image reducers 23(k+1) to 23m are configured to receive the data stored in the kth reduced image memory 22k of the first image reduction unit 210. The (k+1)th to mth image reducers 23(k+1) to 23m are respectively configured to reduction-convert the data received from the kth reduced image memory 22k. The (k+1)th to mth image reducers 23(k+1) to 23m are configured to have different reduction ratios. The image data reduced with different ratios by the (k+1)th to mth image reducers 23(k+1) to 23m are stored in the (k+1)th to mth reduced image memories 24(k+1) to 24m.

The data stored in the (k+1)th to mth reduced image memories 24(k+1) to 24m are provided to the search window setter 130. That is, reduced images of the image to which the standard image has been reduced by the kth image reducer 21k with different reduction ratios are provided to the search window setter 130.

As described above, the standard image, the images to which the standard image is reduced with different reduction ratios by the first to kth image reducers 211 to 21k, and the images to which the image reduced by the kth image reducer 21k is reduced with different reduction ratios are provided to the search window setter 130. That is, the standard image and its reduced images which have been reduced various reduction ratios are provided to the search window setter 130. Accordingly, variously-sized target objects on the standard image may be detected.

In FIG. 4, it has been described that the first and second image reduction units 210 and 230 are provided; however, the present invention is not limited thereto. For instance, additional image reduction unit may be provided for reduction-converting the data stored in one of the (k+1)th to mth reduced image memories 24(k+1) to 24m.

FIG. 5 is a block diagram illustrating an image controller 120a according to a second embodiment of the present invention. Referring to FIG. 5, the image controller 120a includes a standard image memory 121, a first image reduction unit 310, a second image reduction unit 330, and a third image reduction unit 350.

The standard image memory 121 is configured to store the data transferred from the image acquirer 110. In detail, the standard image memory 121 stores partial data (or selected data) among the data transferred from the image acquirer 110. The data stored in the standard image memory 121 is provided of the search window setter 130 and the first image reduction unit 310.

The first reduction unit 310 is configured to reduction-convert the data stored in the standard image memory 121, i.e., the partial data (or selected data) among the data transferred from the image acquirer 110. The second image reduction unit 330 is configured to reduction-convert the data reduction-converted by the first image reduction unit 310 additionally. The third image reduction unit 350 is configured to reduction-convert the data reduction-converted by the second image reduction unit 330 additionally.

The first image reduction unit 310 includes a first image reducer 311 to a third image reducer 313 and a first reduced image memory 321 to a third reduced image memory 323.

The first to third image reducers 311 to 313 are respectively configured to reduction-convert the data stored in the standard image memory 121. The data reduction-converted by the first to third image reducers 311 to 313 are respectively stored in the first to third reduced image memories 321 to 323.

The first to third image reducers 311 to 313 are configured to have different reduction ratios. For instance, the first image reducer 311 has a reduction ratio of about 50%, the second image reducer 312 has a reduction ratio of about 25%, and the third image reducer 313 has a reduction ratio of about 80%. Accordingly, the data of an image to which the standard image is reduced by about 50% is stored in the first reduced image memory 321. The data of an image to which the standard image is reduced by about 25% is stored in the second reduced image memory 322. And, the data of an image to which the standard image is reduced by about 80% is stored in the third reduced image memory 323.

The second image reduction unit 330 includes a fourth image reducer 331 to a sixth image reducer 333 and a fourth reduced image memory 341 to a sixth reduced image memory 343.

The fourth to sixth image reducers 331 to 333 are respectively configured to reduction-convert the data stored in the third reduced image memory 323. The data reduction-converted by the fourth to sixth image reducers 331 to 333 are respectively stored into the fourth to sixth reduced image memories 341 to 343.

The fourth to sixth image reducers 331 to 333 are configured to have different reduction ratios. For instance, the fourth image reducer 331 has a reduction ratio of about 50%, the fifth image reducer 332 has a reduction ratio of about 25%, and the sixth image reducer 333 has a reduction ratio of about 80%.

Accordingly, the image to which the standard image is reduced by about 80% by the third image reducer 313 and is additionally reduced by about 50% by the fourth image reducer 331, i.e., the image to which the standard image is reduced by about 40%, is stored in the fourth reduced image memory 341. The image to which the standard image is reduced by about 80% by the third image reducer 313 and is additionally reduced by about 25% by the fifth image reducer 332, i.e., the image to which the standard image is reduced by about 20%, is stored in the fifth reduced image memory 342. The image to which the standard image is reduced by about 80% by the third image reducer 313 and is additionally reduced by about 80% by the sixth image reducer 333, i.e., the image to which the standard image is reduced by about 64%, is stored in the sixth reduced image memory 343.

The third image reduction unit 350 includes a seventh image reducer 351 and an eighth image reducer 352, and a seventh reduced image memory 361 and an eighth reduced image memory 362.

The seventh and eighth image reducers 351 and 352 are respectively configured to reduction-convert the data stored in the sixth reduced image memory 343. The data reduction-converted by the seventh and eighth image reducers 351 and 352 are respectively stored into the seventh and eighth reduced image memories 361 and 362.

The seventh and eighth image reducers 351 and 352 are configured to have different reduction ratios. For instance, the seventh image reducer 351 has a reduction ratio of about 50% and the eighth image reducer 352 has a reduction ratio of about 25%. Accordingly, the data of an image to which the standard image is reduced by about 32% is stored in the seventh reduced image memory 361, and the data of an image to which the standard image is reduced by about 16% is stored in the eighth reduced image memory 362.

As described above, the data of the standard image and the images to which the standard image is reduced by about 50%, about 25%, about 80%, about 40%, about 20%, about 64%, about 32%, and about 16% are provided to the search window setter 130. Therefore, variously-sized target objects on the standard image may be detected.

For instance, a maximum reduction ratio may be determined according to a resolution of the standard image and a resolution of the search window SW. For instance, the maximum reduction ratio may be determined so that a resolution of a reduced image is not smaller than the resolution of the search window SW.

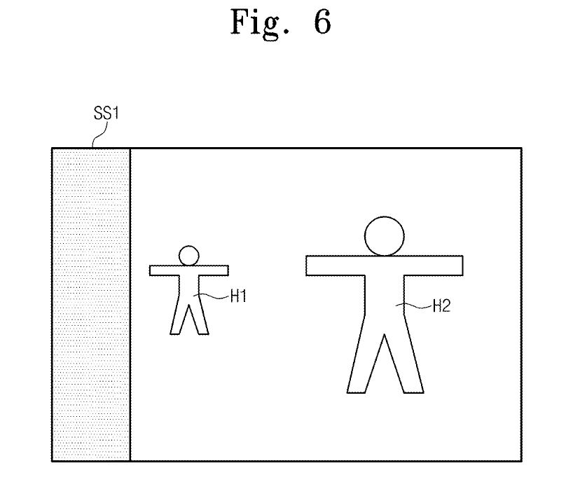

FIGS. 6 to 10 are diagrams for describing an operation method of the image recognizing device including the image controller 120a of FIG. 5. Hereinafter, it is assumed that the horizontal-vertical resolution of the standard image is 640×480. And, it is assumed that the horizontal-vertical resolution of the search window SW is 64×64.

Firstly, a partial region SS1 of the standard image is selected. For instance, as illustrated in FIG. 6, the partial region is selected form the leftmost of the standard image. For instance, a region which corresponds to the horizontal resolution of the search window SW and the vertical resolution of the standard image is selected.

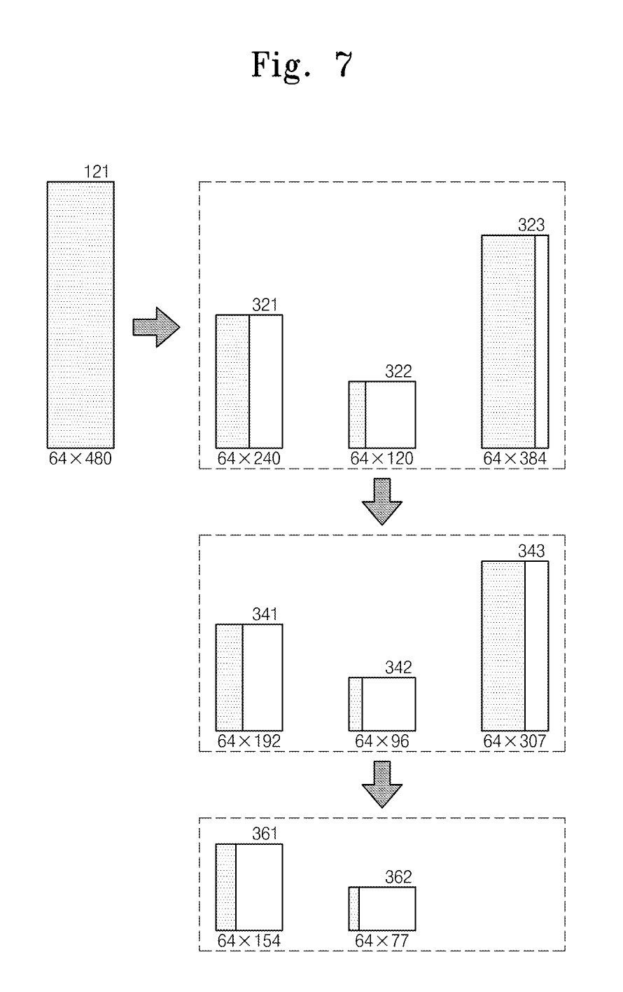

As illustrated in FIG. 7, the standard image memory 121 has a storage capacity of 30720 corresponding to the horizontal resolution 64 of the search window and the vertical resolution 480 of the standard image. If data of the selected region SS1 of the standard image is stored, all the storage capacity of the standard image memory 121 is consumed.

The data stored in the standard image memory 121 is the data of the selected region SS1 whose horizontal resolution is equal to the horizontal resolution of the search window SW. Therefore, the search windows SW may be set from the data stored in the standard image memory 121.

If the search window SW is set based on the standard image memory 121, the image recognition processor 140 detects the target object within the set search window SW. If the image recognition within the set search window SW is finished, the search windows setter 130 sets the search windows SW again. For instance, the search window setter 130 resets the search window SW by varying the vertical coordinates in the selected region SS1 of the standard image. The reset search window SW may include a region overlapped with the initially set search window SW. In the reset search window SW, the image recognition processor 140 detects the target object. Until the recognizing image based on the data stored in the standard image memory 121 is finished, the reset of the search window SW and the recognizing image are continuously performed.

While the recognizing image is performed based on the data stored in the standard image memory 121, the first to third image reduction units 310 to 350 reduction-converts the standard image.

Firstly, the data stored in the standard image memory 121 is reduction-converted by the first image reduction unit 310.

The first reduced image memory 321 has a storage capacity 64×240 corresponding to the horizontal resolution 64 of the search window SW and a vertical resolution 240 to which a vertical resolution of the standard image is reduced by about 50% by the first image reducer 311. A resolution of the data to which the data stored in the standard image memory 121 is reduction-converted by 50% is 32×240. Accordingly, the reduction-converted data occupies about 50% of the storage capacity of the first reduced image memory 321.

The second reduced image memory 322 has a storage capacity 64×120 corresponding to the horizontal resolution 64 of the search window SW and a vertical resolution 120 to which the vertical resolution of the standard image is reduced by about 25% by the second image reducer 312. A resolution of the data to which the data stored in the standard image memory 121 is reduction-converted by 25% is 16×120. Accordingly, the reduction-converted data occupies about 25% of the storage capacity of the second reduced image memory 322.

The third reduced image memory 323 has a storage capacity 64×384 corresponding to the horizontal resolution 64 of the search window SW and a vertical resolution 384 to which the vertical resolution of the standard image is reduced by about 80% by the third image reducer 313. A resolution of the data to which the data stored in the standard image memory 121 is reduction-converted by 80% is 51×120. Accordingly, the reduction-converted data occupies about 80% of the storage capacity of the third reduced image memory 323.

Next, the data stored in the third reduced image memory 323 is reduction-converted by the second image reduction unit 330.

The fourth reduced image memory 341 has a storage capacity 64×192 corresponding to the horizontal resolution 64 of the search window SW and a vertical resolution 192 to which the vertical resolution the standard image is reduced by about 40% by the third and fourth image reducers 313 and 331. A resolution of the data to which the data stored in the standard image memory 121 is reduction-converted by 40% is 26×190. Accordingly, the reduction-converted data occupies about 40% of the storage capacity of the fourth reduced image memory 341.

The fifth reduced image memory 342 has a storage capacity 64×96 corresponding to the horizontal resolution 64 of the search window SW and a vertical resolution 96 to which the vertical resolution the standard image is reduced by about 20% by the third and fifth image reducers 313 and 332. A resolution of the data to which the data stored in the standard image memory 121 is reduction-converted by 20% is 13×96. Accordingly, the reduction-converted data occupies about 20% of the storage capacity of the fifth reduced image memory 342.

The sixth reduced image memory 343 has a storage capacity 64×307 corresponding to the horizontal resolution 64 of the search window SW and a vertical resolution 307 of the image to which the vertical resolution the standard image is reduced by about 64% by the third and sixth image reducers 313 and 333. A resolution of the data to which the data stored in the standard image memory 121 is reduction-converted by 64% is 41×307. Accordingly, the reduction-converted data occupies about 64% of the storage capacity of the sixth reduced image memory 343.

Next, the data stored in the sixth reduced image memory 343 is reduction-converted by the third image reduction unit 350.

The seventh reduced image memory 361 has a storage capacity 64×154 corresponding to the horizontal resolution 64 of the search window SW and a vertical resolution 154 to which the vertical resolution the standard image is reduced by about 32% by the third, sixth, and seventh image reducers 313, 333, and 351. A resolution of the data to which the data stored in the standard image memory 121 is reduction-converted by 32% is 20×154. Accordingly, the reduction-converted data occupies about 32% of the storage capacity of the seventh reduced image memory 361.

The eighth reduced image memory 362 has a storage capacity 64×77 corresponding to the horizontal resolution 64 of the search window SW and a vertical resolution 77 to which the vertical resolution the standard image is reduced by about 16% by the third, sixth, and eighth image reducers 313, 333, and 352. A resolution of the data to which the data stored in the standard image memory 121 is reduction-converted by 16% is 10×77. Accordingly, the reduction-converted data occupies about 16% of the storage capacity of the eighth reduced image memory 362.

The horizontal resolutions of the reduced image memories 321 to 323, 341 to 343, and 361 and 362 are the same, i.e., 64. The horizontal resolution of the search window SW is 64. There exists no full memory among the reduced image memories 321 to 323, 341 to 343, and 361 and 362. Accordingly, the search window SW cannot be set in the reduced image memories 321 to 323, 341 to 343, and 361 and 362. When the search window SW can be no longer set, the standard image memory 121 is updated.

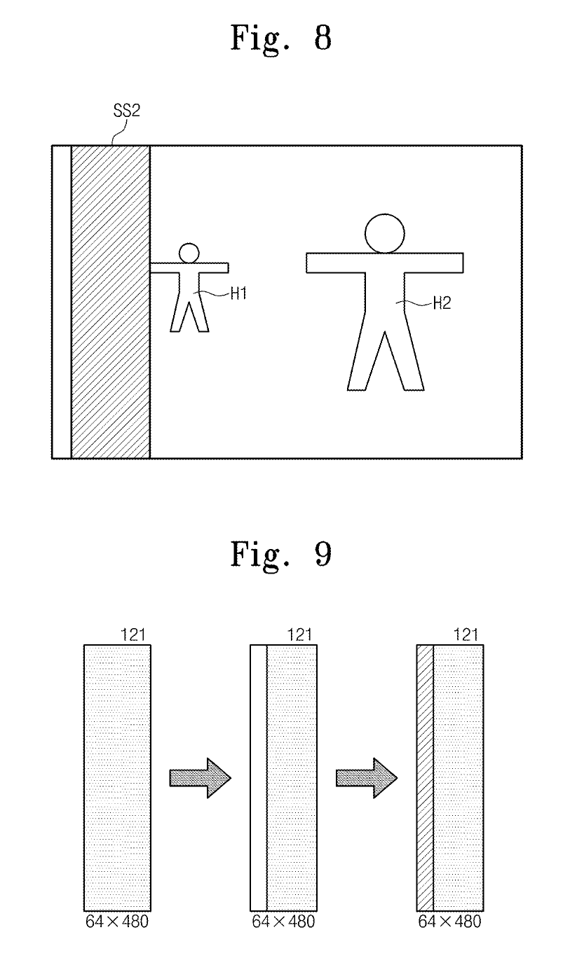

Referring to FIG. 8, a region SS2 moved to the right from the selected region SS1 of FIG. 6 is selected. For instance, the selected region SS1 of FIG. 6 and the selected region SS2 of FIG. 8 may include an overlapped region. Since the selected region among the data of the standard image is changed, the standard image memory 121 is updated.

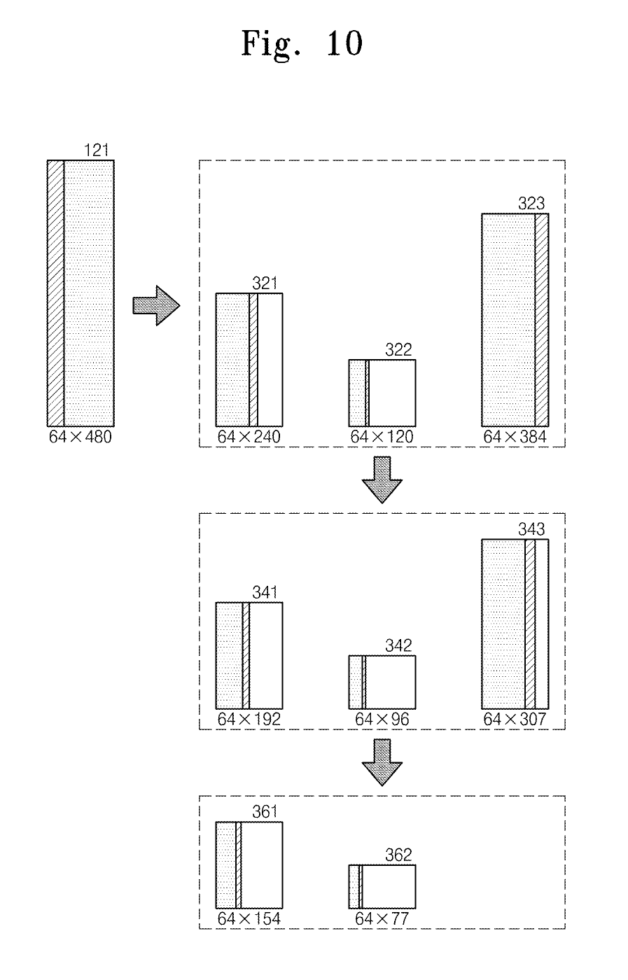

Referring to FIG. 9, it is illustrated that the standard image memory 121 stores the data of the firstly selected region SS1. Among the data of the firstly selected region SS1, data not included in the secondly selected region SS2 is deleted from the standard image memory 121. The common data of the firstly and secondly selected regions SS1 and SS2 is maintained in the standard image memory 121. The deleted storage is illustrated as an empty space.

Thereafter, among the data of the secondly selected region SS2, data not included in the firstly selected region SS1 is stored into the standard image memory 121. That is, among the data of the acquired standard image of the image acquirer 110, partial data which is still not stored into the standard image memory 121, i.e., data of a capacity corresponding to a free storage space of the standard image memory 121, is stored in the standard image memory 121. By updating just the data corresponding to the difference between the firstly and secondly selected regions SS1 and SS2, access to the standard image memory 121 is minimized and the standard image memory 121 may be updated to store the data of the secondly selected region SS2. The updated data in the standard image memory 121 is marked by diagonal lines.

After the standard image memory 121 is updated, the search windows SW is set again based on the data stored in the standard image memory 121. If the image recognition within the set search window SW is finished, the search window setter 130 varies the vertical coordinates to reset the search window SW. The reset search window SW may include an overlapped section with the initially set search window SW. Until the image recognition based on the data stored in the standard image memory 121 is finished, the reset of the search window SW and the image recognition are continuously performed.

While the image recognition is performed based on the data stored in the standard image memory 121, the first to third image reduction units 310 to 350 reduction-converts the standard image.

Firstly, the data stored in the standard image memory 121 is reduction-converted by the first image reduction unit 310. As illustrated in FIG. 10, the first to third image reducers 311 to 313 reduction-convert the newly stored data in the standard image memory 121 and store the converted data into the first to third reduced image memories 321 to 323 respectively.

Next, the data stored in the third reduced image memory 323 is reduction-converted by the second image reduction unit 310. As illustrated in FIG. 10, the fourth to sixth image reducers 331 to 333 reduction-convert the newly stored data in the third reduced image memory 323 and store the converted data into the fourth to sixth reduced image memories 341 to 343 respectively.

Thereafter, the data stored in the sixth reduced image memory 343 is reduction-converted by the third image reduction unit 350. As illustrated in FIG. 10, the seventh and eighth image reducers 351 and 352 reduction-convert the newly stored data in the sixth reduced image memory 343 and store the converted data into the seventh and eighth reduced image memories 361 and 362.

Reduction-converting the data of the secondly selected region SS2, the third reduced image memory 323 become in a full state. Accordingly, the search window SW may be set in the third reduced image memory 323. After the image recognition based on the data stored in the standard image memory 121 is finished, the image recognition is performed based on the data stored in the third reduced image memory 323.

When the search window SW can be no longer set, the standard image memory 121 is updated again. As described above referring to FIG. 10, partial data of the standard image memory 121 is updated. And, the updated partial data is reduction-converted.

Herein, the third reduced image memory 323 is in a full state. The third reduced image memory 323 is updated like the standard image memory 121. That is, data of a capacity corresponding to the data reduction-converted by the third image reducer 313 is deleted from the third reduced image memory 323. And, the reduction-converted data is stored into the third reduced image memory 323. That is, a full memory among the reduced image memories 321 to 323, 341 to 343, and 361 and 362 is also updated whenever the standard image memory 121 is updated.

Whenever the standard image memory 121 is updated, the image recognition is performed based on the data stored in the standard image memory 121. After the image recognition based on the data stored in the standard image memory 121 is finished, the image recognition is performed based on the data stored in a full memory among the reduced image memories 321 to 323, 341 to 343, and 361 and 362. When the search window SW can be no longer set, the standard image memory 121 is updated again.

In the case of a typical image recognizing device, the standard image is acquired, the image recognition is performed to the acquired standard image, the acquired standard image is reduced, and the image recognition is performed to the reduced image. Herein, the image recognizing device should be provided with a memory corresponding to a minimum resolution of the standard image. In the case that the resolution of the standard image is 640×480, the image recognizing device needs a memory with a capacity of 307200.

The storage capacity needed by the image recognizing device 100 according to the embodiment of the present invention is as follows.

TABLE 1

| | |
|---|---|
| Standard image memory 121 | 640 × 480 = 30720 |
| 1st reduced image memory 321 | 64 × 240 = 15360 |
| 2nd reduced image memory 322 | 64 × 120 = 7680 |
| 3rd reduced image memory 323 | 64 × 384 = 24576 |
| 4th reduced image memory 341 | 64 × 192 = 12288 |
| 5th reduced image memory 342 | 64 × 96 = 6144 |
| 6th reduced image memory 343 | 64 × 307 = 19648 |
| 7th reduced image memory 361 | 64 × 154 = 9856 |
| 8th reduced image memory 362 | 64 × 77 = 4928 |
| total | 131200 |

According to the embodiment of the present invention, required storage capacity is reduced. Therefore, unit cost and size of the image recognizing device may be reduced.

Also, according to the embodiment of the present invention, the image recognition for the standard image and the image recognition for the reduced image of the standard image may be performed in parallel. Therefore, within the standard image, the target object may be detected comparing sizes of objects.

In the above embodiment, it is described that the image controller 120a performs the reduction-conversion up to 16% of reduction ratio. If the standard image of 640×480 is 16% reduced, the standard image has a resolution of 102×77. It is exemplified that the resolution of the search window SW is 64×64. That is, if 16% reduction-conversion is performed, the standard image is converted to a resolution similar to that of the search window SW. Therefore, it is exemplified that the image controller 120a performs the reduction-conversion up to 16% of reduction ratio. If the resolutions of the standard image and the search window SW are changed, the range of reduction-conversion of the image controller 120a may also be varied.

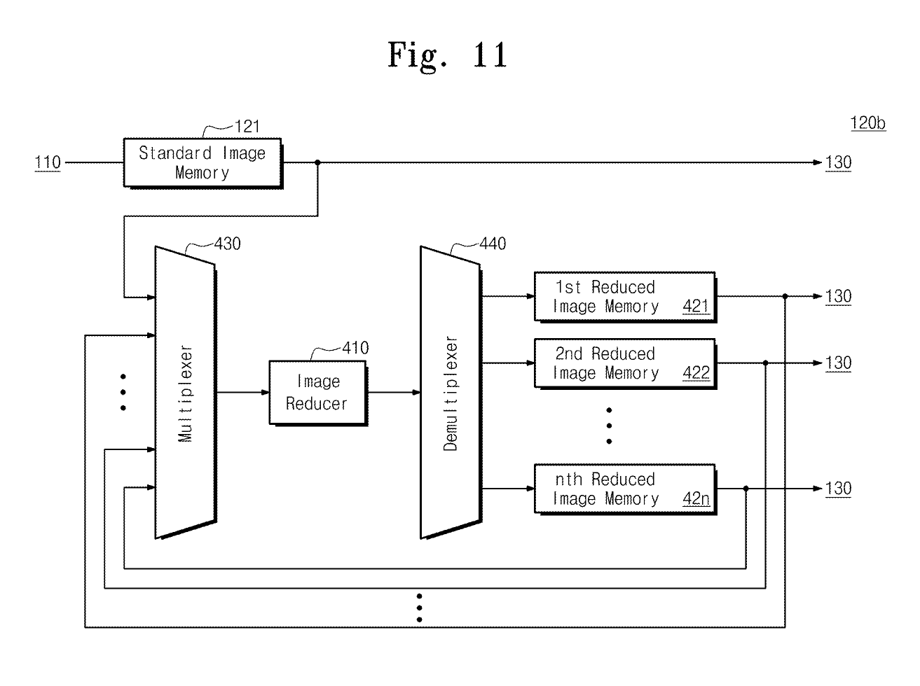

FIG. 11 is a block diagram illustrating an image controller 120b according to a third embodiment of the present invention. Referring to FIG. 11, the image controller 120b includes a standard image memory 121, an image reducer 410, a first reduced image memory 421 to an nth reduced image memory 42m, a multiplexer 430, and a demultiplexer 440.

The standard image memory 121 has the same structure and operation as described above referring to FIGS. 4 and 5.

The image reducer 410 has a particular reduction ratio. The image reducer 410 is configured to reduction-convert data stored in one of the standard image memory 121 and the first to nth reduced image memories 421 to 42n through the multiplexer 430. The data reduction-converted by the image reducer 410 is stored into one of the first to nth reduced image memories 421 to 42n through the multiplexer 430.

The data stored in the standard image memory 121 and the first to nth reduced image memories 421 to 42n is provided to the search window setter 130.

For instance, the data stored in the standard image memory 121 is transferred to the image reducer 410 through the multiplexer 430, reduction-converted, and stored in the first reduced image memory 421 through the demultiplexer 440. The data stored in the first reduced image memory 421 is transferred to the image reducer 410 through the multiplexer 430, reduction-converted, and stored into the second reduced image memory 422 through the demultiplexer 440. The data stored in a kth reduced image memory (k is an integer equal to or larger than 2) is transferred to the image reducer 410 through the multiplexer 430, reduction-converted, and stored into (k+1)th reduced image memory through the demultiplexer 440.

That is, the standard image is continuously reduced by the image reducer 410. The data generated at each reduction-conversion operation are provided to the individually provided reduced image memories. Therefore, the data stored in the standard image memory 121 and the data reduced with various reduction ratios are provided to the search window setter 130.

The reduction conversion, search window (SW) setting, and image recognition are performed in the same manner as described above referring to FIGS. 6 to 10. That is, the image recognition is performed based on the data stored in the standard image memory 121. If the search window SW can be no longer set, the standard image memory 121 is updated. When the standard image memory 121 is updated, only the updated data is reduction-converted to be provided to the reduced image memories. After the image recognition based on the data stored in the standard image memory 121 is finished, if there is a full reduced image memory, the image recognition is performed based on the data stored in the full reduced image memory. The reduced image memory is updated in the same manner as that of the standard image memory.

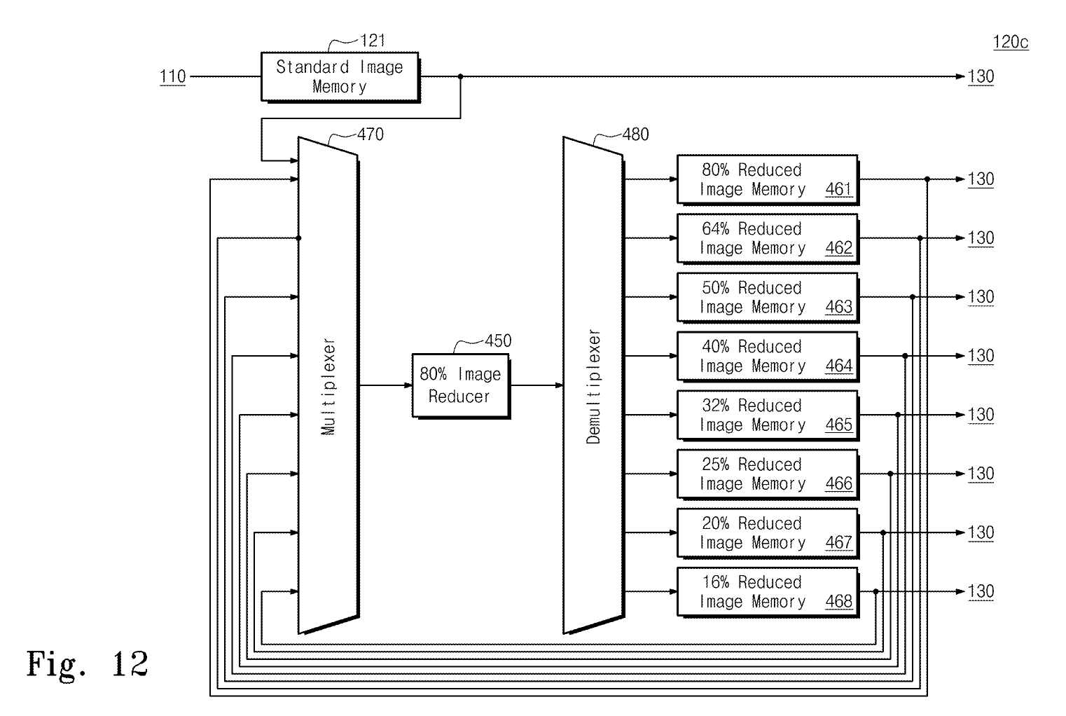

FIG. 12 is a block diagram illustrating an image controller 120c according to a fourth embodiment of the present invention. Referring to FIG. 12, the image controller 120c includes a standard image memory 121, an image reducer 450, a first to an eighth reduced image memories 461 to 468, a multiplexer 470, and a demultiplexer 480.

The standard image memory 121 has the same structure and operation as described above referring to FIGS. 4, 5, and 11.

The image reducer 450 has a reduction ratio of about 80%. The image reducer 450 is configured to reduction-convert data stored in one of the standard image memory 121 and the first to eighth reduced image memories 461 to 42n through the multiplexer 468. The reduction-converted data is stored into one of the first to eighth reduced image memories 461 to 468 through the multiplexer 430.

The image reducer 450 receives the data stored in the standard image memory 121 through the multiplexer 470, reduction-converts the received data by about 80%, and stores the reduction-converted data to the first reduced image memory 461 through the demultiplexer 480. Since the 80%-reduction conversion is performed once, the first reduced image memory 461 stores the 80%-reduced data.

The image reducer 450 receives the data stored in the first reduced image memory 461 through the multiplexer 470, reduction-converts the received data, and stores the reduction-converted data to the second reduced image memory 462 through the demultiplexer 480. Since the 80%-reduction conversion is performed twice, the second reduced image memory 462 stores the 64%-reduced data.

Likewise, the image reducer 450 receives the data stored in the kth reduced image memory (k is an integer equal to or larger than 2) through the multiplexer 470, reduction-converts the received data, and stores the reduction-converted data to the (k+1)th reduced image memory 462 through the demultiplexer 480.

The third reduced image memory 463 stores 50%-reduced data, the fourth reduced image memory 464 stores 40%-reduced data, the fifth reduced image memory 465 stores 32%-reduced data, the sixth reduced image memory 466 stores 25%-reduced data, the seventh reduced image memory 467 stores 20%-reduced data, and the eighth reduced image memory 468 stores 16%-reduced data.

The data stored in the standard image memory 121 and the first to eighth reduced image memories 461 to 468 are provided to search window setter 130. Accordingly, the image recognition may be performed based on the data of the standard image and the data reduced with various reduction ratios.

The reduction conversion, search window (SW) setting, and image recognition are performed in the same manner as described above referring to FIGS. 6 to 10. That is, the image recognition is performed based on the data stored in the standard image memory 121. If the search window SW can be no longer set, the standard image memory 121 is updated. When the standard image memory 121 is updated, only the updated data is reduction-converted to be provided to the reduced image memories. After the image recognition based on the data stored in the standard image memory 121 is finished, if there is a full reduced image memory, the image recognition is performed based on the data stored in the full reduced image memory. The reduced image memory is updated in the same manner as that of the standard image memory.

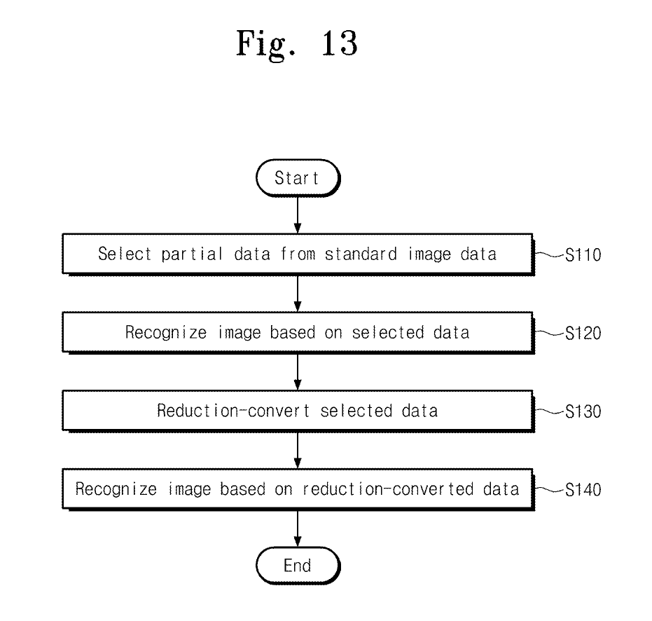

FIG. 13 is a flowchart illustrating an operation method of the image recognizing device 100 according to the embodiment of the present invention. Referring to FIG. 13, in operation S110, a partial data of the standard image data is selected. The horizontal resolution of the selected data corresponds to the horizontal resolution of the search window SW and the vertical resolution corresponds to the vertical resolution of the standard image.

In operation S120, the image recognition is performed based on the selected data. For instance, the image recognition is performed based on the data stored in the standard image memory 121.

In operation S130, the selected data is reduction-converted. For instance, the data of the standard image is reduction-converted by the image reducer. The reduction-converted data is stored into the reduced image memory.

In operation S140, the image recognition is performed based on the reduction-converted data. For instance, the image recognition is performed based on the data stored in the reduced image memory.

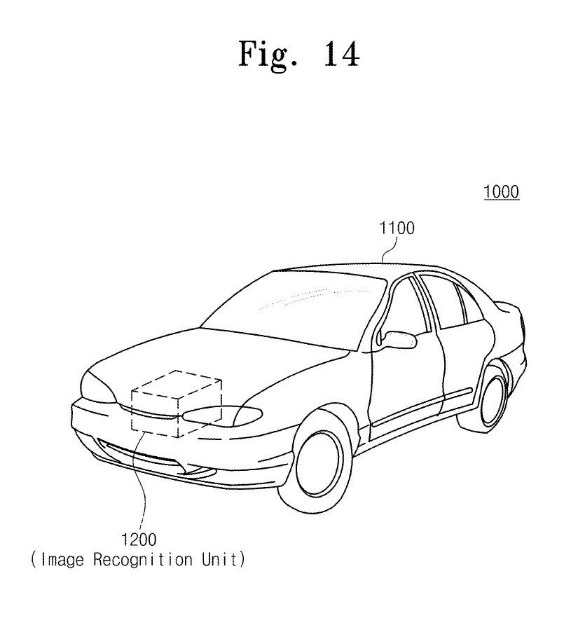

FIG. 14 is a diagram illustrating an image recognition system 1000 according to an embodiment of the present invention. Referring to FIG. 14, the image recognition system 1000 includes a driver 1100 and an image recognizing device 1200. The driver 1100 is operated according to a recognition result of the image recognizing device 1200.

For instance, it is illustrated that the driver is a car. Herein, the driver may generate an alerting sound or may control operations according to whether a pedestrian is detected or whether another car is approaching. For instance, the driver 1100 may self control operations of quick braking, curbing prevention, or cruising drive.

The image recognizing device 1200 has the same structure and operations as described above referring to FIGS. 1 to 13.

The image recognizing device 1200 according to the embodiment of the present invention may perform the image recognition with reduced storage capacity. Also, the image recognizing device 1200 may perform the recognition based on a distance to an object by processing and comparing the standard image and the reduced image of the standard image in parallel. Also, while the image recognition is performed for data of a particular reduction ratio, the reduction operation may be performed in parallel. Therefore, image recognition time may be shortened.

According to the present invention, the memory for storing the standard image and the memory for storing the reduced image are separately provided. Therefore, a storage capacity required for the image recognition can be reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for recognizing an image, comprising:
selecting a partial data from a standard image data;
recognizing image based on the selected data;
reduction-converting the selected data; and
recognizing image based on the reduction-converted data.

2. The method of claim 2, further comprising:
reselecting a partial data from the selected data and unselected data from the standard image data;
recognizing image based on the reselected data;
reduction-converting the reselected data; and
recognizing image based on the reduction-converted data of the reselected data.

3. An image recognizing device, comprising:
an image acquirer;
a standard image memory configured to store a partial data of a standard image data acquired by the image acquirer;
a first reducer configured to reduction-convert the data stored in the standard image memory;
a reduced image memory configured to store an output data of the first reducer;
a search window setter configured to set a search window based on the data stored in the standard image memory and the data stored in the reduced image memory; and
an image recognition processor configured to recognize image based on the search window set by the search window setter.

4. The image recognizing device of claim 3, wherein the search window setter is configured to set the search window based on the data stored in the reduced image memory after the recognizing image based on the data stored in the standard image memory is finished.

5. The image recognizing device of claim 3, wherein the standard image memory comprises a storage capacity corresponding to a horizontal resolution of the search window and a vertical resolution of the image acquirer.

6. The image recognizing device of claim 3, wherein the reduced image memory comprises a storage capacity corresponding to a horizontal resolution of the search window and a vertical resolution to which a vertical resolution of the image acquirer are reduction-converted by the first reducer.

7. The image recognizing device of claim 3, wherein the search window setter is configured to set the search window based on the data stored in the reduced image memory after data corresponding to a horizontal resolution of the search window and a vertical resolution to which a vertical resolution of the image acquirer are reduction-converted by the first reducer is stored in the reduced image memory.

8. The image recognizing device of claim 3, wherein partial data is deleted from the data stored in the standard image memory and data with a capacity corresponding to the deleted data is additionally stored in the standard image memory after the recognizing image based on the data stored in the standard image memory is finished.

9. The image recognizing device of claim 8, wherein the search window setter is configured to reset the search window based on the data stored in the standard image memory after the standard image memory is updated.

10. The image recognizing device of claim 7, wherein the standard image memory is updated based on a First-In First-Out (FIFO) method.

11. The image recognizing device of claim 7, wherein the first reducer is configured to reduction-convert the data additionally stored in the standard image memory.

12. The image recognizing device of claim 11, wherein data to which the additionally stored data in the standard image memory is reduction-converted is stored in a free space of the reduced image memory when the free space exists in the reduced image memory.

13. The image recognizing device of claim 11, wherein data with a capacity corresponding to data to which the additionally stored data in the standard image memory is reduction-converted is deleted from the data stored in the reduced image memory and the data to which the additionally stored data in the standard image memory is reduction-converted is stored into the reduced image memory when a free space does not exist in the reduced image memory.

14. The image recognizing device of claim 13, wherein the reduced image memory is updated in a FIFO method.

15. The image recognizing device of claim 7, wherein the standard image memory is updated when there are data still not stored in the standard image memory among the standard image data after recognizing image based on the data stored in the reduced image memory is finished.

16. The image recognizing device of claim 3, further comprising:
a second reducer having a different reduction ratio from that of the first reducer;
a second reduced image memory configured to store an output data of the second reducer,
wherein the second reducer is configured to reduction-convert the data stored in the standard image memory and store the converted data into the second reduced image memory.

17. The image recognizing device of claim 16, wherein the search window setter is configured to set the search window based on the data stored in the second reduced image memory after the recognizing image based on the data stored in the reduced image memory is finished.

18. The image recognizing device of claim 16, further comprising:
a third reducer configured to reduction-covert the data stored in the reduced image memory;
a third reduced image memory configured to store an output data of the third reducer;
a fourth reducer configured to reduction-convert the data stored in the reduced image memory having a different reduction ratio from that of the third reducer; and
a fourth reduced image memory configured to store an output data of the fourth reducer.

19. The image recognizing device of claim 3, further comprising:
second to nth reduced image memories;
a multiplexer configured to transfer data stored in one of the standard image memory, the reduced image memory, and the second to nth reduced image memories to the first reducer; and
a demultiplexer configured to transfer an output of the first reducer to one of the reduced image memory and the second to nth reduced image memories.

20. The image recognizing device of claim 19, wherein the data stored in the standard image memory is transferred to the reduced image memory through the multiplexer, the first reducer, and the demultiplexer, the data stored in the reduced image memory is transferred to the second reduced image memory through the multiplexer, the reducer, and the demultiplexer, the data stored in the kth reduced image memory among the second to nth reduced image memories is transferred to (k+1)th reduced image memory through the multiplexer, the first reducer, and the demultiplexer, wherein k is an integer equal to or larger than 2.
